(19) United States
(12) Patent Application Publication
(10) Pub. No.: US 2012/0012069 A1
(43) Pub. Date: Jan. 19, 2012

(54) METHOD AND APPARATUS FOR IMPROVED MONITORING AND MANAGING OF LIVESTOCK

(75) Inventors: David W. Hempstead, Idaho Falls, ID (US); Gary A. Johnson, Idaho Falls, ID (US); D. Scott MacGregor, Idaho Falls, ID (US); Antoinette R. Knapp, Idaho Falls, ID (US)

(73) Assignee: Southfork Solutions, Inc., Idaho Falls, ID (US)

(21) Appl. No.: 12/899,851

(22) Filed: Oct. 7, 2010

Related U.S. Application Data
(62) Division of application No. 11/821,583, filed on Jun. 22, 2007, now abandoned.

(51) Int. Cl. A01K 1/00

(52) U.S. Cl. 119/712

(57) ABSTRACT

Operations in a livestock facility can be automated and made more efficient by utilizing an interrogator system that reads and writes data to tags associated with livestock. For instance, gates can be automated to sort livestock based on data read by interrogators from tags and livestock can be identified for examination when data suggest that their behavior deviates from expected or normal behavior. The tag associated with a livestock can carry and accumulate information across multiple facilities throughout the livestock production and processing cycle. Gathering information across facilities allows for more informed decision making and a more cooperative approach to improving the livestock production and processing cycle.

### CLAIM OF PRIORITY

This application is a divisional of and claims the benefit of priority under 35 U.S.C. §120 to U.S. patent application Ser. No. 11/821,583, filed on Jun. 22, 2007, which is hereby incorporated by reference herein in its entirety.

### BACKGROUND OF THE INVENTION

The present application relates generally to methods and apparatus for at least partially automated monitoring and managing of livestock, and more particularly relates to methods and apparatus for performing such monitoring and/or managing through use of electronic tags associated with individual animals. In particular, one aspect of the invention relates to electronic documentation and verification of pertinent data regarding the livestock.

The electronic documentation and verification of livestock aspect of the present invention particularly involves the use of machine-readable/writeable tags associated with individual animals. However, other aspects of the present invention relating to improved monitoring and managing livestock may be implemented with a tag that is machine-readable only, as will be discussed in more detail later herein.

As used herein, the term “livestock” refers to any animal or group of animals which is intended to be monitored and/or managed, regardless of whether the animal(s) is domesticated, semi-domesticated or wild, and regardless of the environment in which the animal may be found, such as, for example, in a commercial animal operation, or in a wild environment.

The term “tag” as used herein relates to any device capable of the functionalities as described herein, regardless of how the device may be associated with an animal, such as by being externally affixed to the animal (for example, in the manner of conventionally-known ear tags, by a collar, or by some other mechanism), or by being implanted or otherwise internally carried by the animal.

The tracking and monitoring of livestock in varying environments is often an issue of significant importance. An example of one such environment which will be used to illustrate the invention is a commercial livestock operation, such as a feedlot, wherein animals such as cattle or swine are raised for food. A commercial feedlot provides a good example of a system for monitoring and managing livestock, in that most foreseeable actions of pertinence to livestock management are typically found in the feedlot environment. In a conventional feedlot, animals will be moved, both individually and in groups, multiple times through the weeks or months they are typically present at the feedlot. Additionally, such feedlots in the U.S. such as are used for cattle typically have substantial numbers of animals to manage; from a few thousand animals to a few hundred thousand animals may be present at any one time. Additionally, as the profitability of the feedlot operation depends upon effective management of the livestock, including its care and feeding, the collection and correlation of data about the animals for management and review is a paramount concern.

Accordingly, in the feedlot environment, there is a recognized need to be able to identify the animals within the operation, and to have a data repository of information about those animals. There is also a recognized need to be able to access that data repository well after an animal has left the feedlot operation. For example, there have been numerous examples of animals carrying disease, where the animal products have eventually ended up in the food chain. When such occurs, there is a recognized need to track backwards from the introduction to the food chain to determine the source and path-to-market of the disease-laden product, so as to evaluate and contain the risks of further contaminated food reaching the public.

One mechanism that has been proposed for meeting such need involves the use of passive, machine-readable radio frequency identification (“RFID”) tags associated with an individual animal. In conventional RFID tagging systems for animals, a tag carrying a single data field of machine-readable data, in the form of a unique identifier, is attached to the animal, to enable identification of the animal. This is an extension of well-known ear tag identification systems, wherein the properties of a physical tag affixed to an animal's ear, such as the color of the tag and a number printed on the tag, are used to identify the animal. The use of a machine-readable RFID tag, enables some automation of logging the presence of an animal when it is within the range of an RFID interrogator. Although such systems are not currently widely used in the U.S., many assume that use of such an electronic identifier system would assist in tracking animals in relation to the food chain. However, such systems, even if widely used would only provide an identification system which would then have to be checked relative to what are currently largely paper records. Thus, even if they were widely used, current electronic identification systems for livestock provide only a limited improvement over long-used paper systems, relative to the actual needs of livestock managers.

In this context, such conventional RFID tagging of livestock has some operational similarities to inventory management systems used by retailers. Retailers utilize radio-frequency identification (RFID) technology for inventory tracking purposes. Machine-readable tags are affixed to each item to be tracked. Interrogators are then used to poll tags within a zone of coverage to identify items within that zone. Such use of RFID technology by retailers has met the inventory tracking and management needs of the retailers while reducing costs.

The tracking and managing of livestock, however, presents substantially different considerations and challenges. Obviously, the tracking and managing of a living animal encounters challenges different than, for example, tracking and managing boxes of soap. These challenges relate not only to the possibility of unintended movement of the animal, but more importantly also to the nature of information which is significant when monitoring livestock. Unlike a box of soap, livestock will often undergo not only changes in physical location, but other changes which would ideally be tracked and recorded. For example, in the identified example of a feedlot, such changes may include: vaccinations, inoculations or other medical treatments; relocation to or from another location and/or entity; groupings with other animals; and changes in the animal's weight or other physical characteristics.

Even to the limited extent that RFID technology is used in the livestock industry, current technologies provide exceptionally limited capabilities. In such conventional uses, passive, machine-readable RFID tags are primarily used for identification of livestock while at a particular facility. The particular facility will use the passive RFID tag on a livestock to identify the livestock and record its presence at the facility. In some cases, the system will then use that identifier in a database or inventory system. Any data from that database or inventory system, however, does not travel with the livestock in the tag and often is not used beyond the particular individual facility. Thus, although there is a well-recognized need to be able to collect, retain, analyze and quickly access information about livestock in the livestock industry, current systems provide only the most rudimentary identification, and do little to address the need for better retention of, and access to, information about the involved animals.

Additionally, the currently-used technologies are less than satisfactory for many commercial and other operations. Currently, the standard passive tags used for monitoring livestock, operate at a frequency of 134.2 kHz. It has been observed that these tags have a limited range in which the tags may be read. Theoretically, the reading range is approximately 29 inches. However, due to attenuation of the signal just by the relation of the animal's body relative to the path between the tag and the interrogator(s) used to read the tags, the practical observed reading range is more commonly approximately 6-12 inches. As a practical matter, this limited range typically requires that the animal be contained within a squeeze chute or other restraint for processing, to assure reliable reading of the tag. This is both time consuming and inconvenient.

Monitoring of livestock is of significant importance even outside of the livestock food industry. For example, it would be useful to be able to monitor certain animals in the wild, or in semi-wild environments, such as a game preserve. Many of the same concerns are present in monitoring animals in wild or semi-wild environments.

Accordingly, current systems for monitoring livestock are of limited capabilities to satisfying the needs of those monitoring and/or managing the livestock. Thus, the present invention provides new methods and apparatus for monitoring livestock, in which different examples of the invention will provide different aspects of improved monitoring and managing of livestock. Thus, in different examples of the invention, there will be different such improvements, examples of which are described herein.

### SUMMARY OF THE INVENTION

The present invention provides a number of improved methods and apparatus for improved managing and monitoring of livestock of all kinds. The invention uses, in all aspects, a machine readable tag associated with each animal involved to enable improved monitoring and documentation of events involving that animal. Some aspects of the invention use a tag which is both machine-readable and machine-writeable, to facilitate establishing a data store of pertinent data carried by the animal. In some examples of this aspect of the invention, this record carried by the animal may be accessed and updated by multiple facilities through which the animal will pass, to provide both improved documentation of the animal throughout its life, and improved access to that documentation. In other aspects of the present invention, there are provided improved systems for monitoring livestock to identify instances in which an animal may need individualized attention, In other aspects of the invention, associating a machine-readable tag, and preferably a machine readable/writeable tag with a head of livestock expands the functionality for automated or semi-automated handing of animals such as automatic sorting or other handling based on one or more data stores in the tag. In another aspect, the present invention provides improved systems, as may be implemented through program instructions, such as software, implemented on processing systems to facilitate management of the livestock. In particularly preferred examples of the invention, such systems will also facilitate and control the documentation and retention of pertinent data regarding the livestock, preferably including creating and accessing a data store carried in the tag on each animal.

### BRIEF DESCRIPTION OF THE DRAWINGS

Some embodiments are illustrated by way of example and not limitation in the figures of the accompanying drawings in which:

FIG. 1 depicts use of a writeable tag on an example head of livestock.

FIG. 2 depicts an example facility for receiving livestock, illustrating one example use of the present invention.

FIG. 3 depicts an example flowchart for intake processing of received livestock.

FIG. 4 depicts an example facility in which multiple monitoring areas are established.

FIG. 5 depicts an example mounting system for interrogators, as may be used in establishing a monitoring area.

FIG. 6 schematically depicts an example of a shipping area of a feedlot facility, depicting use of the present invention.

FIG. 7 depicts an example flowchart for shipping processing of a livestock.

FIG. 8 depicts a conceptual diagram of an example record for livestock, as may be used with the present invention.

FIG. 9 depicts an example flowchart for generating product data from the livestock.

FIG. 10 depicts example operations and events that occur to a livestock in relation to a database and writeable tag.

FIGS. 11A-D depict examples of user interface screens that may be utilized to interface between operators at various levels and the livestock processing system as described herein.

FIG. 12 depicts in block diagram form a processing system as may be utilized with the present invention.

### DETAILED DESCRIPTION OF PREFERRED EMBODIMENTS

The description that follows includes illustrative systems, methods, techniques, instruction sequences and computing machine program products that illustrate example of the present invention. In the following description, for purposes of explanation, numerous specific details are set forth in order to provide an understanding of various embodiments of the inventive subject matter. It will be evident, however, to one skilled in the art that embodiments of the inventive subject matter may be practiced without these specific details. For instance, examples are described with reference to RFID technology, which is one preferred implementation of the invention. However, the invention is not limited to use of RFID tags. Other mechanisms for reading and writing electronic information might be used in other embodiments in accordance with the present invention. In general, well-known instruction instances, protocols, structures and techniques within the capabilities of those in the relevant arts have not been shown in detail.

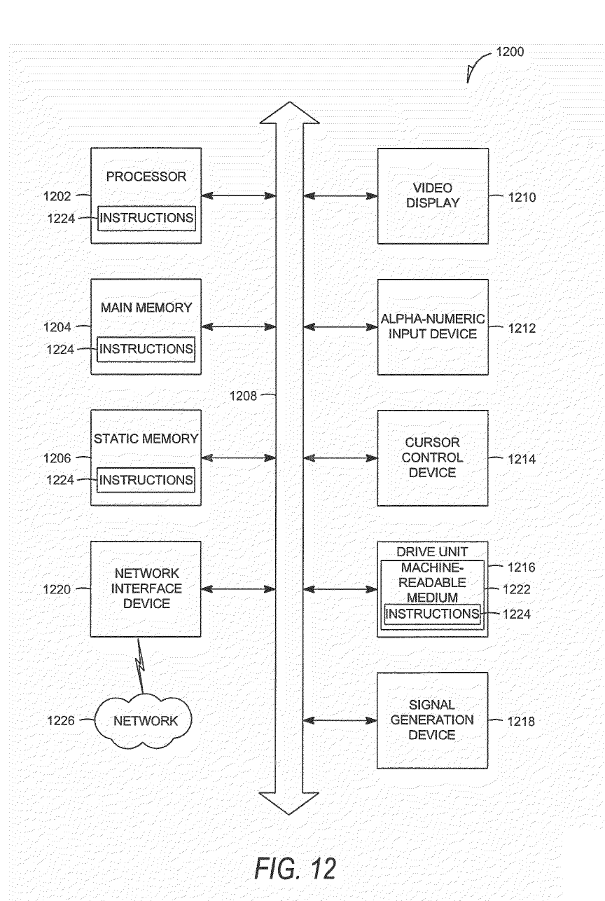

For the purposes of this specification, and as will be addressed in more detail below, a “processing system” includes a system using one or more processors, microcontrollers and/or digital signal processors having the capability of running a “program,” which is a set of executable machine code. Processing systems include computers, or “computing devices” of all forms (desktops, laptops, PDAs, servers, workstations, etc.), as well as other processor-based communication and electronic devices such as cell phones, tablets, personal data assistants, etc. Such processing systems may be discrete units, or may be formed of multiple components, which may be networked or otherwise capable of being placed in operative communication with one another, at least at needed intervals. Processing systems will be addressed in more detail in reference to FIG. 12. A “program” as used herein, includes user-level applications as well as system-directed applications or daemons.

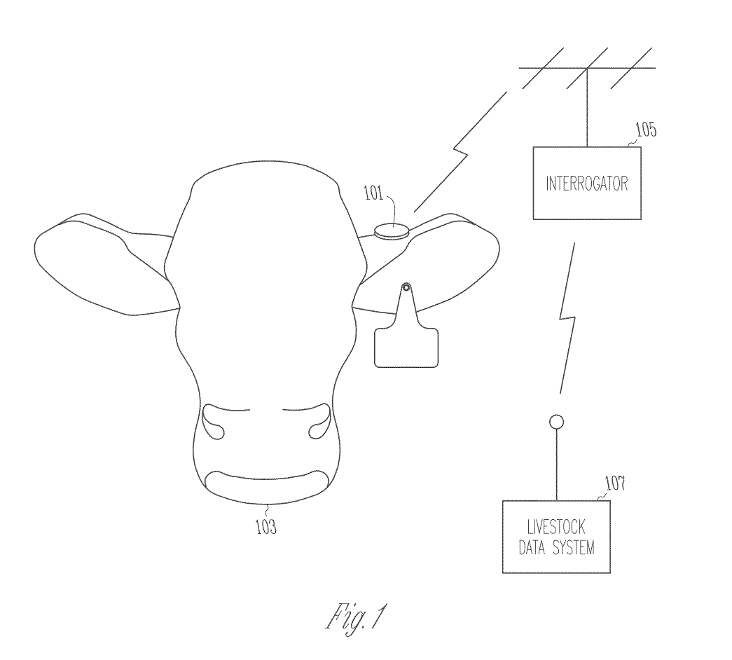

FIG. 1 schematically depicts one example of the three principal components used in the various aspects of the invention as will be discussed herein. The invention uses a tag 101 associated with each head of livestock 103, wherein the tag 101 includes at least a machine-readable component. Some aspects of the invention are implemented through use of a tag that is both machine-readable and writeable, and thus use of such a tag is preferred for usage. Accordingly, the tags will be discussed herein as being both machine-readable and writeable. However, for those aspects of the invention which may be implemented without use of a machine-writeable tag, that fact will be identified.

In accordance with particularly preferred examples of the inventions, tags operating at relatively higher frequencies, such as 2.45 GHz have been found to be satisfactory. However, tags may also be used that operate at a lower frequency, with tags operating at within a range of from approximately 400 to 956 MHz. being preferred, and with tags operating at a frequency of 915 MHz being particularly preferred. Tags operating in the described frequency range exhibit improved range of readability and data transfer. Where tags that are machine-readable and writeable are used, it is preferred that these tags have a memory capacity of at least 256 KB, with a capacity of 2 MB or more being preferred. Preferably this memory will be non-volatile memory, such as SRAM, or more preferably flash memory. Such read/writeable tags will preferably be active RFID tags, having a power source as well as an antenna, a processor and the described memory, which may be integral with or separate from the memory, although semi-active tags may also be used in some applications. An example of one suitable tag, one which operates at the above-noted 2.45 GHz frequency, is described in U.S. Pat. No. 6,130,602, assigned to Micron Technology, Inc. of Boise, Id. Tags of this type are available as the “standard range tag,” from ID Micro, of Tacoma, Wash. In the remainder of the disclosure, reference numeral 1003 will be used to indicate the preferred active read/writeable tags in accordance with the broader frequency range and other configuration examples identified above.

Although FIG. 1 depicts the livestock 103 as a head of cattle, as noted earlier herein, the livestock may be any animal, including chickens, cattle, buffalo, pigs, deer or other wild animals, etc. Notwithstanding the read/write capability of the tags, it is preferred that some protections be provided to avoid the alteration of the unique identifier in each tag that will be used to identify the animal. Such protections can be provided by conventional mechanisms, including hardware or software protections implemented in the tags, the interrogators or the controlling software.

At least one, and preferably multiple, interface units will read data from, and write data to (as appropriate), the read/writeable tag 101. As noted previously, preferred implementations of the invention, particularly those relating to electronic verification and documentation, use RFID tags for readable/writeable tag 101. In such embodiments the read/write interface unit will be RFID interrogators 105. The interrogators 105 communicate data read from readable/writeable tag 101 to a livestock processing system 107. Similarly, livestock processing system 107 communicates data to the interrogators 105, which is then written to readable/writeable tag 101. The connections between any interrogator or interrogator groups in the system and the livestock processing system can be by any suitable mechanism, including wired or wireless networks or a mixture of such. The data that is written to the tag 101 and the data that is read from the tag 101 by the interrogators 105 may vary with the event or operation being conducted with respect to the livestock 103. As will be discussed below, interrogators will be used to establish various monitoring zones, within which each of the interrogators defining that zone will be able to communicate with tags on livestock within that zone.

Livestock processing system 107 is in at least selective communication with the interrogators 105. Livestock processing system 107 is a “processing system,” as defined above, which is schematically depicted as a single box. However, as is apparent from the discussion of processing systems above, and as further discussed in more detail elsewhere herein, livestock processing system 107 can be formed any of many possible configurations of hardware and software. For purposes of this discussion, livestock processing system 107 will be discussed as being a single unit. However, it should be expressly understood that the described functionality and data storage of livestock processing system 107 may be divided between multiple computers or other devices, running multiple programs, which together provide the functionality. Accordingly, in the various examples below, different reference numerals will be used to refer to livestock processing systems performing different functions or handling different data. It should be clearly understood that these example systems may be different systems, or may (and preferably will), all be part of the same livestock processing system. Livestock processing system 107 operates programs which enable the data handling as discussed herein through control of and/or communication with the interrogators 105, providing the interface to tags 103. The combination of these three principal components will enable the various aspects of the invention as discussed below.

Electronic Documentation and Verification

In the course of operating a commercial livestock operation such as a feedlot, there are a number of events that will occur relative to an animal that will be important to some aspect of the operation. For example, animals may be maintained in various programs or certifications which have specific requirements as to feed, medical treatments, supplements, etc. One concern in such an operation is to assure that animals are placed and treated in accordance with such programs or certifications. Another concern is the need to verify what medicines, feed, supplements, or other treatments given to an animal are most successful and/or produce the greatest value for the operator.

In order to document and verify the data pertinent to the above monitoring or to enable the management evaluation, one aspect of the present invention includes the monitoring of events regarding an animal at a facility that includes creating a database identifying at least a portion of those events which will be carried by the animal. In one preferred example of this aspect of the present invention, that database will be maintained on the animal through use of the machine-readable/writeable tag. In particularly preferred examples of the invention, one or more additional databases will also be maintained at the facility through use of one or more processing systems. The database stored in the tag on the animal may contain essentially all the data stored in the facility database, or may contain only a portion of that data. Through implementation of this aspect of the invention, information may not only be used at the facility (as will be described herein), but may also be accessed and used at downstream facilities which may receive the animal. In commercial livestock operations, such facilities may be a ranch, a feedlot, an auction house or packing facility, etc.

In documenting the data pertinent to addressing the above needs, various events occur during the production and processing cycle at a livestock facility that will involve data pertinent to the above-described needs. When those events occur, such pertinent data will be read from and/or written to a tag, and preferably also to a facility database. Such events may encompass various situations or operations. The particular events or operations that occur to a livestock will vary with the type of facility at which the animal is located. As noted above, the example of a feedlot is believed to provide a useful example of use of various aspects of the present invention, and will be used to provide an explanation of the invention.

In a feedlot, at a high level, the categories of events that may occur include: the receipt of the livestock at the facility, either by birth of a calf (in the case of a cattle feedlot) or receipt of an animal from another livestock facility; the monitoring of livestock through movements within the facility; the maintaining of the livestock, such as through medicines or other treatments and/or feeding protocols; the shipping of the livestock; and the generating of products from livestock. Additional categories of events might also be performed and/or tracked.

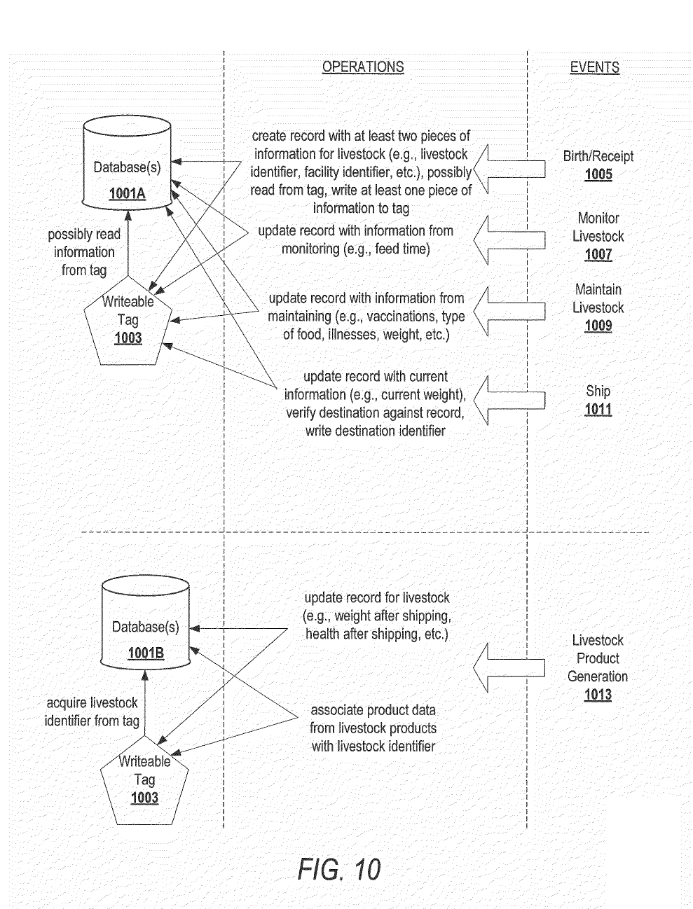

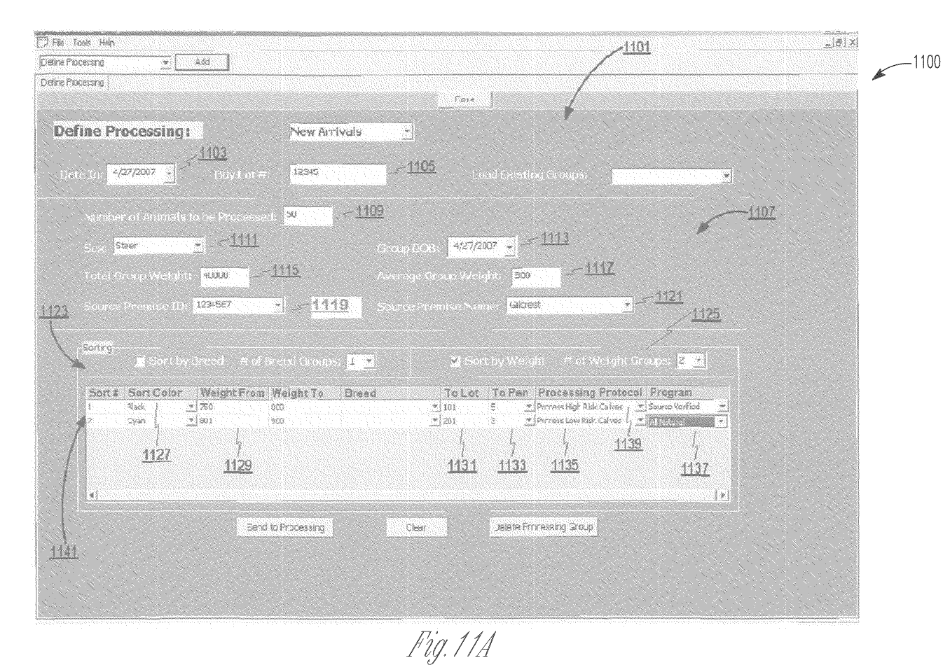

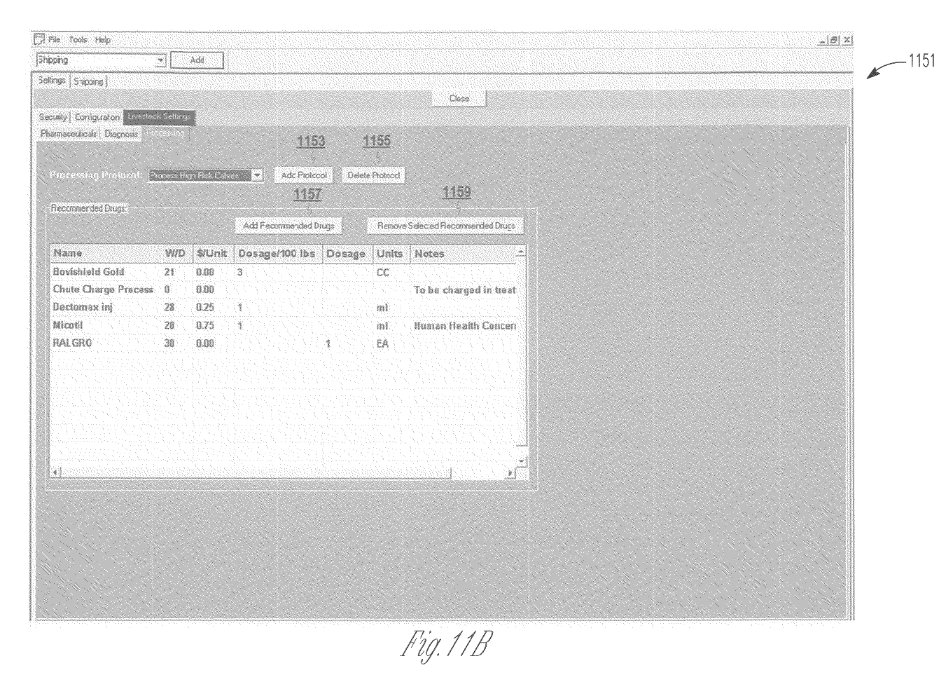

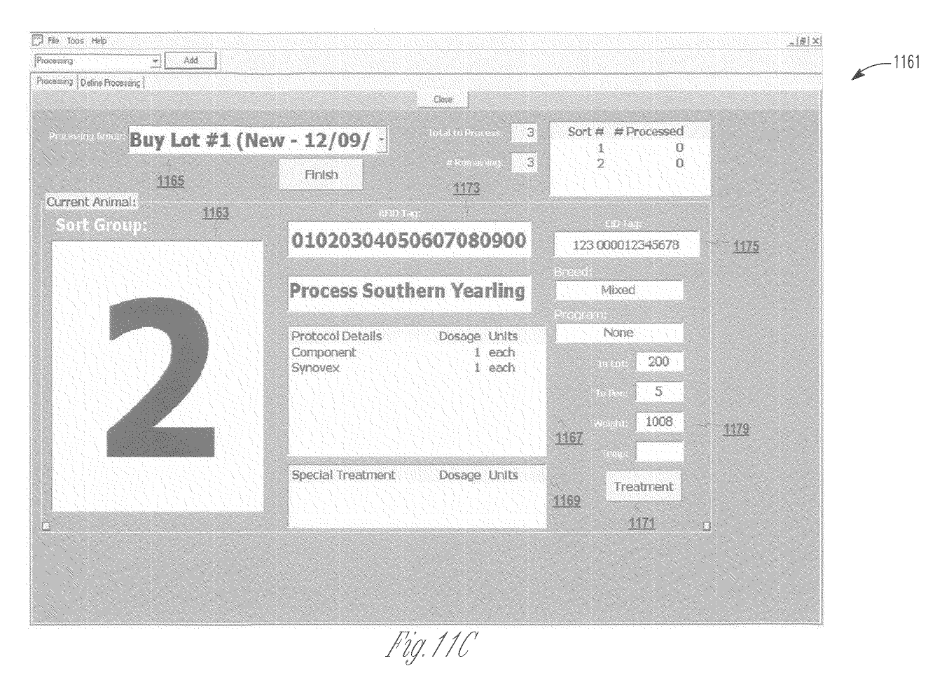

FIG. 10 depicts examples from the above categories of events that may occur to an animal in the feedlot environment, and the documentation of those events as an example of how this aspect of the present invention may be practiced. As noted above, a first event category that will often occur at the example feedlot environment is receipt of an animal 1005, either through shipment or birth. The birth/receipt event 1005 involves creation of a record in a database(s) 1001A preferably with at least two separate pieces of information for the animal. If the livestock is received from another facility wherein the present invention is utilized, such information may be read/downloaded from a tag already on the animal, and recorded in the database 1001A to create the initial record at the facility in question. In the event of a birth event, it will be preferred to also record any information known about the bloodlines producing the animal. As will be discussed in more detail below, any information about the physical or genetic sourcing of an animal may provide data pertinent to evaluating and improving feedlot operations.

In these examples using a read/writeable tag, at least one of the two pieces of information is written to the tag 1003 as well as being written into the database 1001A. It is possible that a tag might be hard coded with both a unique identifier and such a second piece of information through known mechanisms, such as programming of a read only memory (ROM) in the tag. In currently preferred examples of the invention, however, more than two pieces of such information will be written into database 1001A. In addition to any data that may be read from a tag 1003 already associated with the animal, any additional information not already on the tag (such as, for example, the date of receipt at the subject facility), will also be written to tag 1003.

As to the next identified category of events, while an animal remains at the facility, it will preferably be monitored 1007 to assure the animal is handled appropriately. For example, livestock may be sorted and physically separated into groups on a variety of bases. Such bases can include, in different operations: the weight of the animals, indicative of an expected duration of stay in the feedlot; the feeding, medical, growth supplement or other protocol planned for the animal; and other groupings as may be useful in the feedlot operation. In most cases, these groupings will be achieved by physical separation of the groups into separate pens. The sorting or physical grouping intended for the animal will again preferably be written to the tag 1003 associated with that animal, and may be updated in the event that the intended grouping changes. Additionally, the invention contemplates using the tags to track animals through movements within the feedlot, to assure that each animal which is to travel a certain path to arrive at a given destination, does in fact do so.

Additionally, in some cases, the monitoring 1007 may include collecting data that will be useful in identifying, interpreting or modifying behavior of individual livestock. The collected data can be used, for example, to identify any animals that may be behaving differently than one might expect from a normal or healthy animal, as a way of identifying an animal that may need special attention. For instance, a deviation in time spent at a feed bunk may indicate that an animal is ill. As will be discussed in more detail later herein, the present invention contemplates in some examples, the monitoring of the time an animal spends in certain areas, as determined by RFID interrogator zones of coverage. Examples of such areas might be feed or water troughs. The information collected as to a group of animals, for example all animals within a given pen, may then be plotted or otherwise compared over one or multiple time periods to determine animals that exhibit behavior outside of the norm. In that way, the present invention contemplates monitoring of livestock to determine animals that warrant special attention of some type.

The next category, of maintaining the livestock 1009, involves operations that are operator-initiated. Examples of the operator-initiated operations include weighing livestock, administering a medicine, growth supplement or other treatment to an animal, taking an animal's temperature, taking blood from an animal, physically examining an animal, etc. Again, documentation of each of these events will preferably be recorded not only in a facility database, but will be recorded in readable/writeable tag 1003 on each animal. In preferred examples of the invention, the recorded data will include information including the date and time of the event. In the case of any materials injected or otherwise administered to the animal, an identification of the material as well as the dosage will be recorded. In this manner, the animal will carry data sufficient to indicate compliance with a given protocol, program or certification. Additionally, having the data carried by the animal facilitates evaluation of the history of that animal not only at the current facility, but at any later facilities through which the animal may pass.

Data documenting these types events may also be used to inform decisions with respect to facility operations. For instance, data may be used to evaluate the effectiveness of certain medications, vitamins, hormones, and/or supplements administered to livestock. As one example, a first group of livestock administered a growth supplement may be evaluated, such as in terms of weight gain over a selected time period, relative to a second group administered a second growth supplement.

As to most operator-initiated events, the operator may either input the identifying data into the database 1001A, or the data may automatically be written to the database 1001A. For example, a scale may automatically indicate a weight range or specific weight that is communicated to the database 1001A without operator involvement. In most cases the data will also be written at generally the same time to the tag 1003 on the animal.

At some point, time at a facility for a livestock draws to a close and the livestock is shipped to another facility. When a shipping event 1011 occurs, the record in the database 1001A for the livestock is updated with various information. Examples of the information include an indication of current weight, a destination identifier, etc. In addition, a verification operation may be implemented to verify the shipping destination and satisfaction of shipping requirements from data in the record of the livestock being shipped.

Although livestock may be shipped to an intermediate facility, livestock are eventually shipped to a packing facility, where the livestock product generation event occurs 1013. Either a new record is created or an existing record is updated in a database 1001B at the packing facility, upon receipt of livestock for product generation. After product generation, product data is associated with the livestock identifier and written to the database 1001B, and, perhaps, the writeable tag 1003. Various information (e.g., weight upon receipt, health status upon receipt, time of travel, etc.) may be written to the tag 1003 and to the record in the database 1001B. In preferred implementations, the tag 1003 will travel with the animal carcass through at least a portion of the process. In that manner, data pertinent to the ultimate evaluation of the feedlot operation may be gathered. Examples of the product data include yield, carcass quality, product grade, carcass defects, etc. In preferred examples of the invention, each tag 1003 may be returned to the feedlot, thereby enabling efficient updating of the feedlot records. However, it is preferred that the information will be transmitted electronically to the facilities identified in the tag 1003 as having previously received the animal. Because each such location should have a record correlated with that animal through the tag 1003 identifier, each such facility will be able to evaluate the data pertinent to its operation. In this manner, the data may be used to improve efficiency and profitability throughout the commercial livestock process.

As illustrated in FIG. 10, data for a livestock can be collected from the birth of the livestock to generation of livestock product from the livestock for numerous uses. The data collected across facilities can be used to identify trends (e.g., effects of feeding in certain climates, weights of natural livestock versus weights of conventional livestock, type of feed against weight gained (or lost), etc.). A facility may review data to drive their selection of certain suppliers and services providers, such as the suppliers of livestock, feed, supplements, vaccines, transportation, etc., based on performance of the service and or supplies with respect to returns on the livestock from generated livestock product. In addition, data may be used to allow a facility to efficiently adhere to regulations or protocols. For example, the data may be used to ensure that a processing facility operation adheres to regulations for maintaining or acquiring a desired certification for the product. Additionally, by facilitating improved data correlation through multiple facilities, the data may be used to improve efficiency and profitability throughout the commercial livestock process. Additional examples of the implementing the invention will be discussed in reference to the figures below.

Example Livestock Receiving Facility and Process

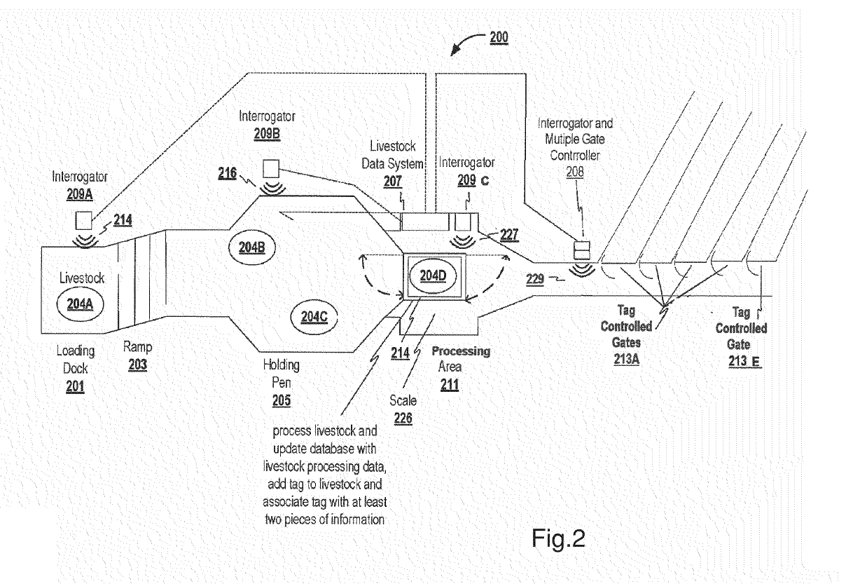

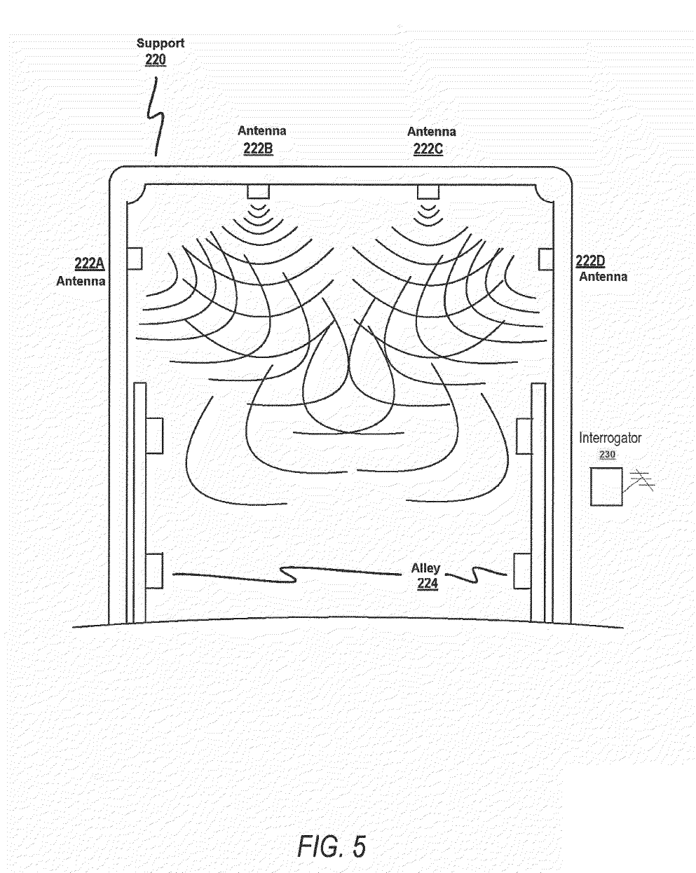

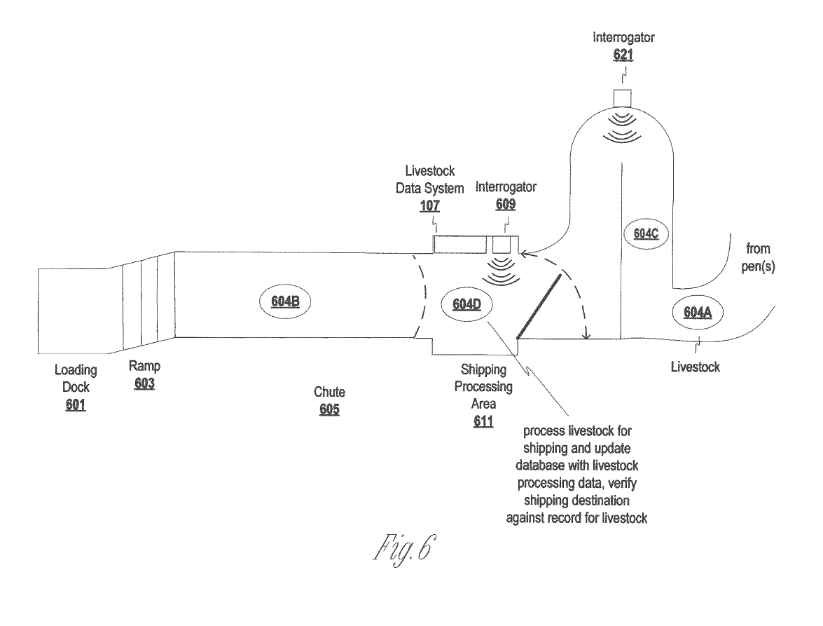

FIG. 2 schematically depicts one example of a receiving facility 200 for receiving of livestock, such as either new arrivals or existing animals needing medical or other processing, illustrating one example use of the present invention; while FIG. 5 depicts one configuration for establishing a monitoring zone, as described in reference to FIG. 2. Receiving facility 200 includes a loading dock 201, where livestock 204A-204D are received, such as by being unloaded from a truck. Livestock 204A-204D advance from the loading dock 201 down the ramp 203 to a holding pen 205, while waiting intake processing in a processing area 211. One or more monitoring zones 214, 216, 227, 229 may be established at desired locations along this path, through interrogators or interrogator systems 209A-C and 208. As depicted in FIG. 5, each such monitoring zone will include at least one RFID interrogator 230 and will include at least one, and preferably multiple antennas 222A-D to establish a zone of coverage in which tags will be read. It has been found that by using interrogators having embedded software controlling the interrogators' adjustable parameters such as the units, power, range, etc. with multiple ports coupled to two to four antennas 222A-D can provide reliable coverage across an alley 224 up to approximately 16 feet wide, such that tagged livestock can be reliably read even when moving quickly with multiple animals abreast. Use of interrogators with multiple antennas is typically preferred for effective monitoring. In many cases, particularly where the tags 1003 are attached to the ears of the animals, it is preferred that the multiple antennas be distributed generally above or to the side of the livestock, such as through an overhead support 220, to provide improved reading of the tags as the animals traverse the monitoring zone.

For example, as depicted in FIG. 2, interrogators may be placed to establish a first monitoring zone 214 at the head of the loading dock to read tags on animals immediately as they leave the shipping truck. Additionally, depending on the physical distances and configuration, it may also be useful to have another monitoring location 216 proximate holding pen 205, where animals will be held while awaiting processing in processing area 211.

In this example, processing area 211 will be a location for intake processing of each received animal. In many feedlot operations, when livestock are received, the operator will have previously established a processing protocol for the livestock. This protocol may be based on a wide variety of factors, including the source providing the livestock, the time in transit, compliance with any desired regulatory or determined protocols (such as for organic livestock, “all natural” livestock, etc.), any perceived health issues, etc. All of these possible factors are well known in the industry, and feedlot operators will use their experience to establish the protocol for the received animals. In this example, processing area 211 is the initial location for beginning to implement the established protocol. Accordingly, processing area 211 will typically be a building or other covered area, with squeeze chutes 214 or other facilities to enable operations such as injection of individual animals in accordance with the desired protocol. Additionally, there will typically be a scale 226 for weighing each animal individually, either in or before processing area 211.

Because particularized treatments will be given in processing area 211, it is preferred that a monitoring zone be established for each squeeze chute 214 that will read only a tag of an animal in that chute. If only one chute is provided, as depicted, the major concern will typically be just to assure that the monitoring zone does not extend to animals in front or behind that chute 214. Where multiple chutes are provided, the concern will also go to avoiding cross coverage of the chutes. In most cases, this can be achieved by orientation and/or power adjustment of the interrogators through the interrogator hardware, software or application software).

In processing area 211, the monitoring zone is provided by at least one interrogator 209C, operatively coupled to livestock data system 207. Livestock data system does not need to be physically located in receiving area 211. However, it is preferable that at least one terminal and data input device associated with at least a portion of livestock data system 207 will be located in receiving area 211. Such terminal and user interface may be conventional separate components such as a monitor and mouse or keyboard, or may include, for example, a touch screen for receiving at least some user inputs.

Once an animal is in chute 214 in processing area 211, if the animal 204D has not been previously associated with a machine-readable/writeable tag 1003, then operators tag the animal 204D and create a database record for it. If the animal already has a machine-readable/writeable tag associated with it which contains data in accordance with the present invention, that information may be read from the tag into a record for the animal. It should be understood that as an alternative, records for the shipped animals may also be transmitted to the receiving facility electronically from a source facility. At least two pieces of separate information are associated with the livestock at least one of which uniquely identifies the animal. Preferably, a much larger group of data will be written to the tag.

For example, as operators process the livestock 204D a database of the livestock data system 207 will be updated to document operations performed on the livestock by recording various parameters, such as type and quantity of vaccines administered, drugs administered, vitamins administered, hormones administered, category of livestock (e.g., natural, organic, etc.), and the initial weight of livestock (e.g., specific weight, approximate weight, weight range), etc.

After intake processing, the livestock will be released to pens, typically selected in accordance with desired groupings, as described earlier herein. In some examples of the invention, the sorting of animals into pens may be automated in response to data either in the tag on the animal or in the database. For example, as the animal leaves processing area 211 and heads toward the sorting which maybe one to an unlimited number of gates, an interrogator 208 may be used to read that sorting parameter, or other data functionally indicating an assigned grouping for the animal from tag 1003, and to automatically open a gate 213A-213E, as appropriate, while keeping the other gates closed. For example, if the animal 204D has been categorized as an “organic” animal (one to be raised according to protocols classifying it as “organic”), then the gate controller 208 opens the gate 213E to the organic pen(s).

As an alternative, instead of placing gates 213A-213E under the specific control of an interrogator 208, as depicted, control of gates 213A-213E might be performed by livestock data system 207. For example, when interrogator 208 reads the tag of an approaching animal, that information would be communicated to livestock data system 207, which could then determine the sort group through reference to the database, and which would then control the opening of the appropriate gate 213A-213E. If the interrogator of the gate controller 208 reads that the livestock 204D has been categorized as a conventional livestock, then the gate controller 208 opens the gate 213A to the conventional pen(s).

Although in the depicted example of FIG. 2, a livestock protocol category is used as an example of a sorting parameter, the sorting parameter may be one or more other variables written to a tag. For example, livestock may be sorted based on weight. In that example, an indication of a weight or weight range is written to the tag, which causes the gate controller 208 to open a first gate to a pen for cattle with a recorded weight of more than 1,000 pounds and a second gate for cattle with a weight within the range of 800-1000 pounds, or any other selected weight range. The control may be performed in any preferred manner. As a couple of several possible examples, the data field may be written with a data identifier indicating the sorting group in any desired manner (i.e., “Group A” vs. “Group B”) or the interrogator might read an actual weight which would be processed by the livestock data system 207 to determine the sorting group. And as noted previously, virtually any desired parameter can be used as a sorting parameter.

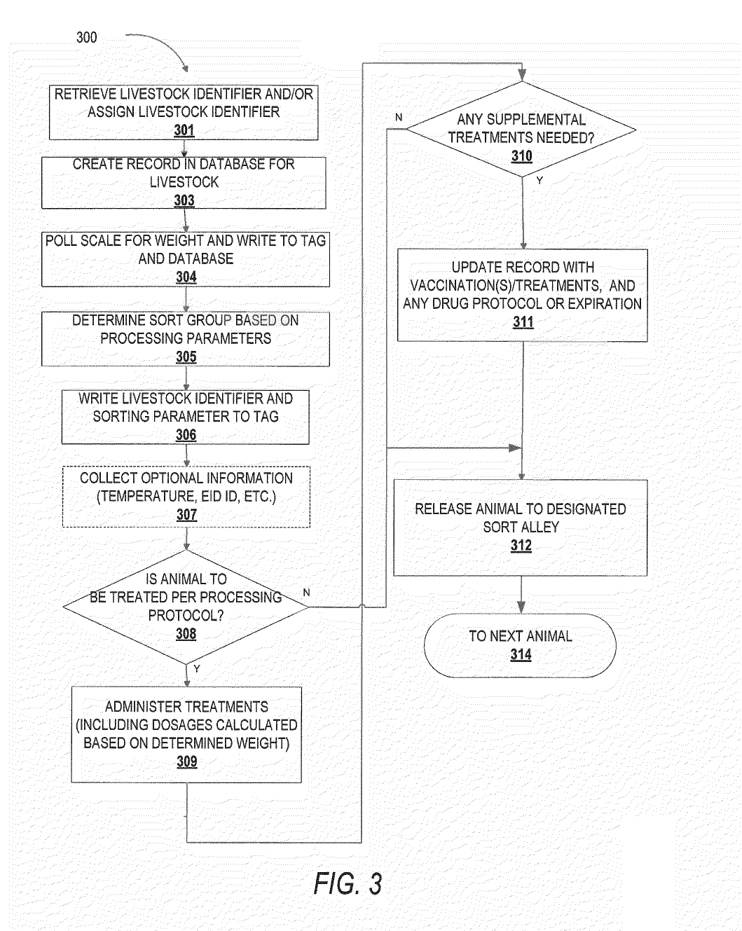

Further elaborating on the receiving operation discussed in reference to FIG. 2, FIG. 3 depicts an example flowchart for one example method 300 for intake processing of a received animal. A similar but abbreviated version of this flow would be used when processing a group of existing animals for medical or other treatments. At block 301, a livestock identifier is retrieved from a tag associated with the animal, is present. If no appropriate tag and or data is present, a tag will be associated with the animal.

At block 303, a record for the animal is created in a database of the facility livestock processing system. Alternatively, the record may be previously established, such as through electronic transmission of records for the animals being shipped to the facility. As noted above, this record will be associated with the animal through a unique identifier, such as a numeric or alpha-numeric sequence. In some cases, the tag may be pre-coded with the unique identifier which will be associated with the animal through the database. In other cases, another data block may be coded with a second piece of data, such as a facility or sorting identifier.

At block 304, the scale will be polled to determine a weight for animal currently in the processing area, and for which a record is open. That weight may then be written both to the tag and the database, as it may be used in determining treatment dosages, as set forth below.

At block 305, a sort group will be established for the animal. As shown by examples later herein, that sort group can be based on any of a variety of factors. That sort group, as well as a livestock identifier (if not already in the tag), will then be written to the tag, at block 306.

As indicated by optional block 307, other types of information may be collected about the animal. This information can include physical data, such as the animal's temperature; or identification information such as an additional identifier, such as a physical ear tag identifier, or a conventional passive ear tag identifier.

At block 308 a determination will be made as to whether the animal is to receive further treatments, such as would typically be defined in a processing protocol, as discussed in more detail later herein. As noted previously, in most cases a protocol will be established for the received animals. If this is the case, then at block 309, operations are performed on the livestock in accordance with the established protocol. Particularly in the case of administered drugs and biologicals, in many cases the dosage will be based upon the weight of the animal. In preferred examples of the invention, the livestock data system 207 will determine the correct dosages based on the established protocol, and will display those dosages to the operator, to facilitate administering of the drugs or biologicals. The treatments administered, including for example, any administered vaccination(s), doctoring protocols, substance protocol (e.g., a protocol for any vitamins, vaccines, hormones, etc.), etc. will be documented in the record. In preferred examples of the invention, data fields indicative of the most or all of the above information will also be written to the tag on the animal. In such cases, not only is there a record in the facility database of the livestock processing system (207 in FIG. 2), but a similar record will be maintained in tag 1003 on the animal.

In the event that either the answer at decision block 308 is “no”, or at the conclusion of the treatments of block 309, a determination will be made at block 310 as to whether any supplemental treatments are needed by the animal. For example, a particular animal might be seen to be lame, and to thus require treatments outside of the established processing protocol. If no such supplemental treatments are required, then the animal will be released to the sort alley at block 312. If supplemental treatments are desired, then they will be administered and the records updated appropriately at block 311; after which the animal will be released to the sort alley, at 312. Once the animal is released, the system will recognize the identifier of the next animal to enter the processing area (if the identifier is present), and the process begins again for the next animal 314.

Livestock Monitoring

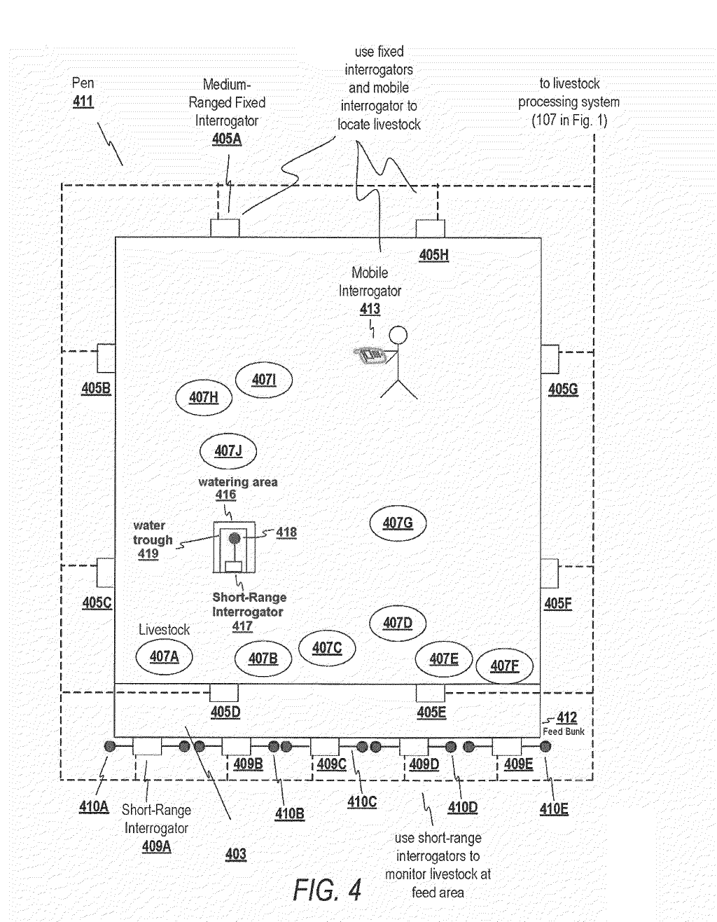

After intake processing, livestock are sent to appropriate pens, as identified in reference to FIG. 2. In some examples of the invention, further benefits will be obtained by establishing monitoring areas in these pens, such as with interrogators. FIG. 4 depicts an example feedlot pen 411 in which multiple monitoring areas will be established, each with particular purposes and advantages, as will be described. It should be clearly understood that other inventive aspects of the invention may be used independently of any use of the pen monitoring areas as described in reference to FIG. 4, or with fewer than all of the areas as described. Additionally, the capabilities as described in reference to this FIG. 4 may be practiced without use of a tag that is writeable, but that is only readable.

Referring now to FIG. 4, pen 411 includes a first monitoring area covering essentially the whole pen, established by a number of medium-ranged fixed interrogators 405A-405H. The medium-ranged fixed interrogators surround the area that contains livestock 407A-4071. The interrogators will be arranged and configured such that the established zone of coverage extends only within pen 411. The pens may have varying antenna configurations from directional, omni directional, leaky cable, etc. in support of the interrogators. In this way, the pen may be monitored to confirm that both: (1) all livestock which should be in the pen are present, and (2) that no livestock that should not be there are present. As is well known in the example feedlot industry, cattle may end up in pens other than the one in which they are intended to be found, either through their own actions, or inadvertent actions of operators. In the depicted example, pen 411 also includes a feed area monitoring region 403 established through one or more short-range interrogators 409A-409E. The short-range interrogators 409A-409E are located along the feed area 403, and are configured to monitor the livestock 407A-407I only when they feed. In some implementations, the monitoring zone may be established by one or more interrogators, operating though use of one or more an antennas 410A-410E extending longitudinally along a surface of feed bunk 412. The surface might be the outer edge of feed bunk 412 (as depicted), or might be located anywhere along the feed bunk fence. This monitoring region 403 may be used to collect data indicating when each animal is at the feeding area, and the length of time each animal spends at the feed bunk 412. In preferred examples, the interrogators will poll the available tags at fairly frequent intervals to identify animals that are present. This polling time may be a short as a few seconds, and that information will be communicated back to livestock processing system 207. Livestock processing system 207 will then compile the received data as needed. In a preferred example of the system, the data will be compiled to indicate any animals that did not feed with a selected time frame, and also to establish a comparison of time spent at the feed bunk for those animals that did visit the bunk. This comparison may be according to any selected mechanism as may be desired. In presently envisioned examples of the invention, the comparison will yield a statistical comparison of such time at the trough sufficient to indicate any outliers, representing animals that spent either an exceptionally long or an exceptionally short time at the trough, or the statistical comparison of an individual animal's average daily time spent at bunk. Such statistical variations of time at the feeding trough may indicate that an animal is suffering from an illness, or that some other condition warranting further examination is present. In the depicted example, pen 411 also includes a watering area monitoring region 416 established through one or more short-range interrogators 417. The short-range interrogator 417 is located on or near the watering area 416, and is configured to monitor the livestock 407A-407I only when they drink. In some implementations, the monitoring zone may be established by one or more interrogators, operating though use of one or more antennas 418 monitoring only animals within the watering area 416.

This monitoring region 416 may be used to collect data indicating when each animal is at the watering area, and the length of time each animal spends at the water trough 419. In preferred examples, the interrogators will poll the available tags at fairly frequent intervals to identify animals that are present. This polling time may be a short as a few seconds, and that information will be communicated back to livestock processing system 207. Livestock processing system 207 will then compile the received data as needed. In a preferred example of the system, the data will be compiled to indicate any animals that did not drink within a selected time frame. In presently envisioned examples of the invention, the data will yield statistics to indicate any outliers, representing animals that have spent either an exceptionally long period of time, an exceptionally short period of time, or no time at the water trough. Such statistical data of time at the watering trough may indicate that an animal is suffering from an illness, or that some other condition warranting further examination is present and needs medical attention. As an alternative implementation to either of the above monitoring techniques, the polling of tags may be done through use of mobile interrogators, rather than fixed interrogators, as depicted in FIG. 4. For example, interrogators with an appropriately established field range can be used to monitor animals in a pen, or animals at a feed bunk. For example, such interrogators may be mounted on a truck that will be driven past the pen or feed bunk to take a survey of animals present. As one example, interrogators mounted on the feed truck would typically pass by the bunk at least twice a day. By polling the animals with a field extending only a few feet into the pen behind the feed bunk it would be possible to determine which cattle are at the feed bunk and ready to eat, and thus which ones are not, and could possibly be sick. Identified animals can also be checked to confirm they are in the correct pen.

As another example, as depicted in FIG. 4, a majority of the livestock 407A-4071 are at the feed bunk 412, but not all. The livestock 407A-407F are at the feeding trough 412, while the livestock 407G-407J are not at feed bunk 412. As another example of the present invention, an operator may decide to further evaluate a particular animal. For example, the previously-described evaluation of presence at the feed bunk might be assumed to indicate that animal 407H has not visited the feed bunk 412 for a determined time period, and thus the operator wants to locate and evaluate that particular animal from the many in the pen. To identify the proper animal, an operator takes a mobile interrogator 413 into pen 411. The operator uses the mobile interrogator to send polling signals to locate the unique tag identifier associated with animal 407H.

Depending upon the RFID protocols used, several techniques for performing this location may be used. As one example, the interrogator may be configured to be capable of sending a signal which will be received by, and acknowledged by only the single tag of interest. In another known RFID protocol, the interrogator may send a signal polling for all tags within range, and sending signals to tags other than the one desired to go inactive for a selected period of time. In such a way, the interrogator can indicate such as through an audible signal, a visual signal or signal strength received only from the tag on the desired animal. By moving through the pen with the interrogator, the operator will be able to localize the signal and thus identify the animal of interest, animal 407H. The mobile interrogator 413 may suppress the tags of all livestock except the one of interest.

### Example Livestock Shipping Facility and Process

Eventually the livestock are shipped. The shipping process involves operations for shipping that again may generate data to be written to the database and to the tags of the livestock. FIG. 6 schematically depicts an example of a shipping area of a feedlot facility. Livestock 604A-604D to be shipped are brought from pens to the shipping facility. The livestock pass through a first monitoring zone established by interrogator (or interrogator group) 621, which may be used to provide an initial screening that all cattle intended for shipment have arrived from the pens, and that no unintended livestock are present. In some implementations, this data may also be used to cache all records of the livestock for more rapid access by livestock processing system 207. The livestock then pass to a shipping processing area 611, where further data about each animal may be confirmed. An additional interrogator 609 may be used to identify the specific animal in shipping processing area 611. For example, if all livestock to be shipped are to be of a certain protocol, such as an “organic” protocol, the records associated with each animal may be confirmed to assure that all necessary requirements have been complied with. Additionally, the animals may be weighed to assure that they meet any maximum or minimum weight limits that may have been established for the shipment. Once all such parameters are confirmed, each animal may traverse a chute 605 and a ramp 603, to a loading dock 601, and from there to a truck or other transport vehicle.

An important advantage of one aspect of the present invention is that the writing of pertinent data fields to the machine readable/writeable tag on the animal as described herein allows a subsequent recipient of the animal to confirm the protocols that were used for treating and feeding the animal. Thus, such a recipient can have greater confidence in the product being received. Additionally, any questions about the animal's history may be addressed much more expediently than is currently possible.

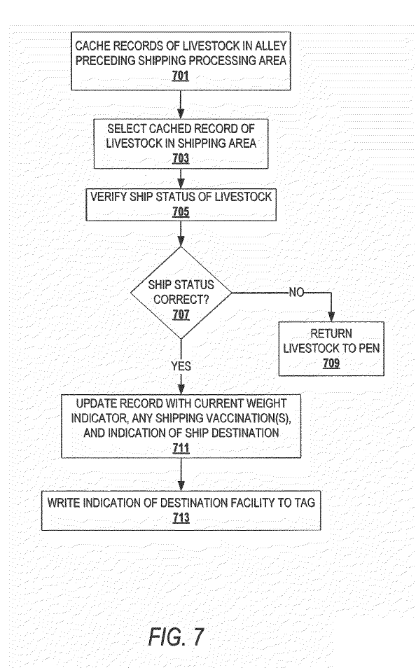

FIG. 7 depicts a flowchart for one example method for shipping processing of livestock. At block 701, records of livestock in an alley preceding a shipping processing area are cached, as previously described in reference to FIG. 6. At block 703, a record of an individual animal in the shipping processing area is selected. At block 705, ship status of the livestock is verified, as discussed above. At block 707, it is determined if the ship status is correct. At block 709, the livestock is returned to the pen if the ship status is not correct. For example, at block 707 it might be determined that a head of livestock no longer satisfies a requirement for shipping weight, or no longer meets a medicine withdrawal protocol. In those cases, the animal may be culled from the shipping group 709.

If the ship status is correct at block 707, then the selected record is updated 711 with a current weight of the livestock, any substances administered to the livestock for transportation, and an indication of the destination. At block 713, the destination indication is written to the tag associated with the livestock. Of course, additional information may be written to the selected record and/or tag, or to a national animal identification system if adopted.

### Recording of Product Data

Generation of data regarding the products of the animal will typically be generated at a different facility, such as a packing facility. Accordingly, establishing an animal record at that facility, and population of a data field for the animal's products will typically occur once the animal reaches that facility and as it undergoes processing. The product data may be written to the tag that is associated with the livestock, or may be recorded in one database and communicated back to facilities upstream from the product generation facility, etc. Thus, data across facilities can be compared and correlated to the various data collected for the livestock with respect to the product data.

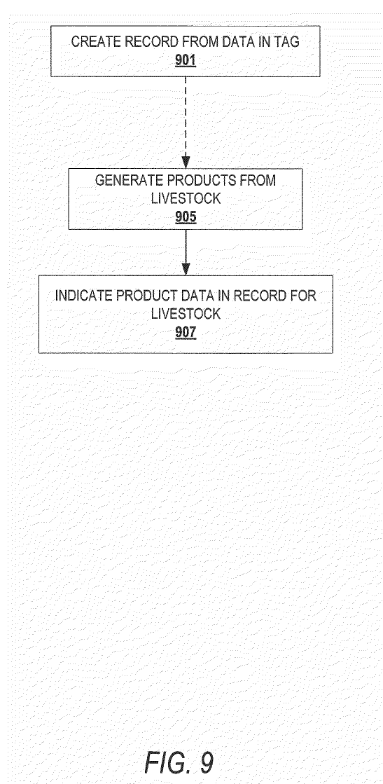

FIG. 9 depicts an example flowchart for generating product data. At block 901a record is created from data in the tag. This record will preferably be a facility database record, established through interrogation of the tag. At block 905 products from the livestock are generated. The generation of such products may include several pertinent data points, including, the carcass weight, the yield and grade, as well as any other metrics which might be considered to impact either the quality or the pricing for the animal. At block 907 this selected product data is written to the record for the livestock. As noted previously, this data may be written to the tag, which may be physically returned to the source of the livestock for updating of the record for that animal at the source facility. However, as the complete history of the animal, at least from the point at which the tag was affixed to the animal is recorded, that record may be transmitted electronically to all source facilities identified in the record that previously housed the animal.

Livestock Processing System

Data Format

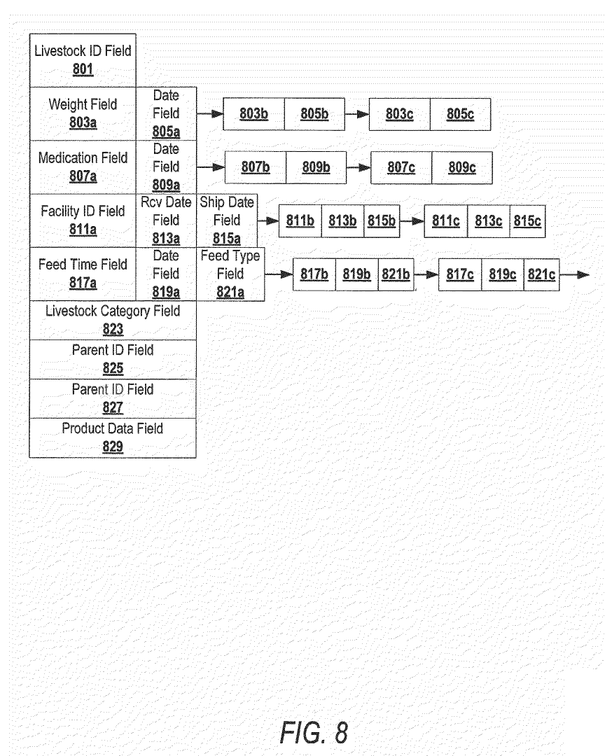

FIG. 8 depicts a conceptual diagram of an example record for use in accordance with the present invention. The example record is illustrated in FIG. 8 as an array, some rows of which are linked lists. It should be appreciated that implementation of a livestock record is not to be limited by this conceptual representation. Numerous structures are possible, but one conceptual example is provided to aid in understanding embodiments instead of obfuscating embodiments with a myriad of structural permutations that utilize (individually or in combination), trees, hash tables, arrays, etc. Furthermore, the record may be implemented with various conventional data storage and/or hardware implementations. A first row of the example record includes a livestock identifier field 801. A second row of the example record includes weight fields 803a-803c and date fields 805a-805c. Each time a weight is taken for a head of livestock, this row is updated with an additional weight and date field. Recordation of this information allows for an operator to view history of weight gain (or loss) and investigate any events that correlate to significant changes with the dates. A third row of the example record includes medication fields 807a-807c and date fields 809a-809c. Each time the livestock is given a vaccine, this row is updated to indicate the vaccine and date administered. The field may also indicate additional information, such as the brand of vaccine, delivery technique, etc. A fourth row of the example record includes facility identifier fields 811a-811c, receive date fields 813a-813c, and ship date fields 815a-815c. This row is updated when a livestock is received, and when a livestock is shipped. With this information, a user can view the history of facilities visited by a livestock and correlate the dates at particular facilities against other data, such as weight or vaccines. A fourth row of the example record includes feed time fields 817a-817c, date fields 819a-819c, and feed type fields 821a-821c. With this information, different types of feed can be evaluated against changes in weight as well as monitoring livestock for unexpected feeding behavior. The example record also includes a livestock category field 823, parent identifier fields 825 and 827, and a product data field 829. Data in the livestock category field 823 indicates whether the livestock is conventional, organic, natural, natural grass fed, etc. The parent identifier fields 825 and 827 allow other data to be correlated with the parents of the livestock for evaluation of genetics. Although depicted as a single field, the product field 829 may host a multitude of data for product generated from the livestock or may reference another record with the product data. Examples of product data include yield, carcass defects, carcass quality, grade, cuts, etc. The fields depicted in FIG. 8 are for aiding in the understanding of embodiments and not meant to be limiting upon embodiments. Fewer or additional fields may be indicated in a livestock record (e.g., a breed field, color markings field, gender field, etc.).

### User Interface

Another aspect of the present invention is the providing of an interface to facilitate processing of animals, such as in accordance with the examples as discussed herein. In preferred implementations, the interface will be provided by a program implemented by at least a portion of livestock data system 107. Preferably, an appropriate interface will be provided at any location where direct interaction between an operator and an animal is planned to occur.

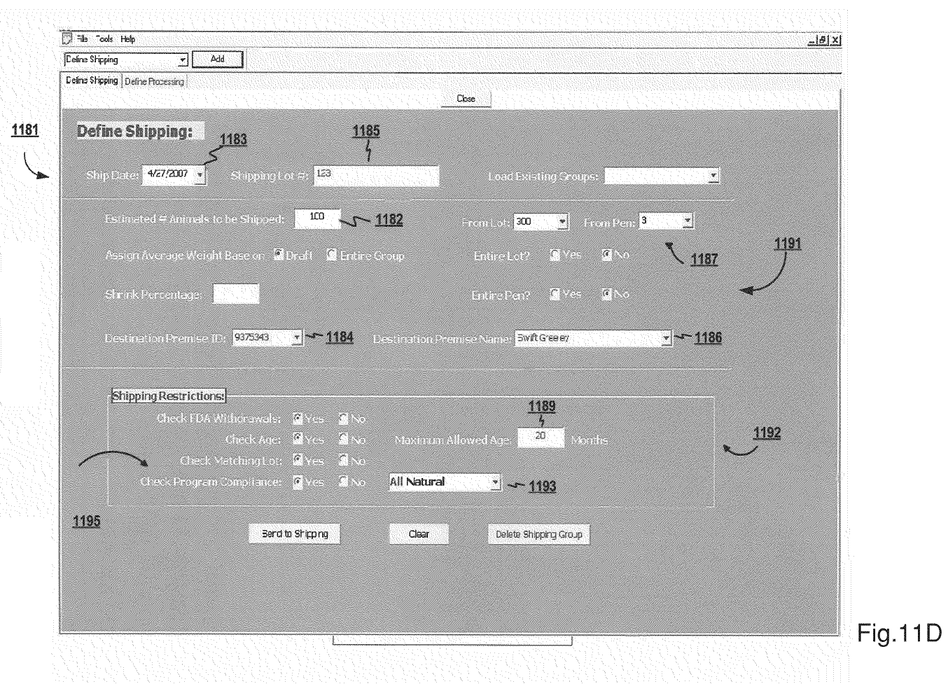

Referring now to FIGS. 11A-D, therein are depicted example interfaces as may be provided in accordance with the present invention. Referring first to FIG. 11A, therein is depicted an example user interface that may be presented to an operator to define processing for livestock to be received, as discussed previously in reference to FIGS. 2 and 3. As can be seen in FIG. 11A, the interface 1100 includes a first section 1101 in which basic information may be provided. In this example, that basic information includes the date of receipt of the animal 1103 and an indicator of the transaction through which the livestock were acquired, here the buy lot number 1105. There is a section 1107 providing information about the animals to be processed, including the number of animals 1109, the gender 1111, the group date of birth 1113, the total group weight 1115 and the average weight 1117, as well as the source from which the livestock were acquired, here identified by both an identifying number 1119 and name 1121. Additionally, the interface 1100 provides a mechanism to select sort groups for the incoming livestock from between multiple options 1123, 1125, and to select further options, including the sort color 1127, the sort weights 1129, the location in terms of the lot 1131 and pen 1133, the processing protocol 1135 for the livestock, and the category for which protocols should be followed 1137. In the depicted example, the selection has been made to sort by weight 1125; and to use a processing protocol for “high risk calves” 1139 for a first sort group 1141. Because the sort information is identified in the program, the sort information may be utilized to facilitate control of at least some portions of the sorting operation, as discussed in reference to FIG. 2. Once the receiving process has been identified, it will be saved and made available for operators of the receiving facility as discussed in reference to FIG. 2, through use of the “send to processing” button 1143 on the interface.

Referring now to FIG. 11B, therein is depicted an interface 1151 which is depicted as having been used to define an example processing protocol for “high risk calves,” as was selected 1139 for the first sort group 1141 in FIG. 11A. The depicted user interface 1151 provides a mechanism to add or delete protocols 1153, 1155; or to modify an established protocol by adding recommended drugs or removing recommended drugs from the protocol 1157, 1159. In preferred implementations of the invention, the drugs and biologicals for each protocol will be selected from a master list of drugs and biologicals, which have been previously selected for possible use. In particular, it is preferred that the protocols for drugs and biological products be defined using standardized identifiers. This usage enables all persons or entities reading a tag or database to have a common understanding of the products administered to the animal in question. For example, the FDA Center for Veterinary Medicine maintains a database of approved animal drug products, identified with a 6-digit numeric system identifying the drug and manufacturer. Similarly, the USDA Animal Plant Health Inspection Service-Veterinary Services (APHIS VS) maintains a database of all licensed biologicals, represented by respective alphanumeric identifiers. By using these codes in Livestock Processing System 207, a uniform reference standard for treatments is established.

Referring now to FIG. 11C, therein is depicted an example of a user interface 1161 as might be made available to an operator at the point of processing, such as in processing area 211, as discussed in reference to FIG. 2. This interface 1161 displays the livestock group being processed 1165, and the sort group 1163 to which the selected animal belongs as determined by parameters defined as described in FIG. 11A. The animal is identified in this example by both tag 1003 number 1173 and an passive 134.2 kHz tag number 1175. As discussed earlier, where an animal is received that already has a tag implemented in accordance with the present invention, the reading of that tag may be used to open a record such as depicted in this FIG. 11C. As can be seen, the sort group 1163 is clearly indicated, as is the processing protocol name 1177, and the details of that protocol 1167. Accordingly, the operator is made aware of the two injections, as identified at 1167, that the animal is to receive. In one example of the invention a control button 1171 (labeled “treatment”) may be actuated on the interface screen 1161, to input to the system any additional treatments 1169 given to the animal. Such information may include the expiration date for any treatments, such as antibiotics, since such could impact, for example, the ability to ship an animal for which the treatment had not expired. At that point, in preferred examples of the invention, the administered drugs, biologicals, dosage date, standardized drug and biological identifiers, lot number 1180, pen number 1181, weight 1179, program 1183 and temperature 1182 if taken, and any other information will all be written to records for the animal in both the facility database and the database in the RFID tag 1003 on the animal.

As alternatives to the process described above, it should be noted that the interface may be cooperatively coupled to the drug injector, such that mere operation of the device to treat the animal will result in updating of the data record. As another alternative, where dosages of drug need to be adjusted in response to the body weight of the animal, the proportions may be established in the treatment protocol, as depicted in FIG. 11B, and the program may calculate the required dosage in response to the monitored weight 1179. In even more sophisticated examples of the invention, the program may establish settings on an associated injection device to establish the determined correct dosage. In addition to documenting receiving protocol treatments, the user interface will also provide similar screens to identify protocols for various treatments that may be contemplated, such as treatments for various conditions, periodic supplements, etc.

Referring now to FIG. 11D, therein is depicted an example user interface 1181 to define a shipping processing protocol for livestock, as was discussed in reference to FIG. 6. An operator may use this interface 1181 to define a shipping protocol which will assure shipment of the proper animals, and that allows verification that the animals meet all criteria deemed necessary or desirable for shipping. Similar to information identified for livestock as being received, interface 1181 identifies the shipping date 1183 and an identifier, here a shipping lot number 1185. Another section 1191 provides data identifying the number of animals to be shipped 1182, and the location from which they will come 1187, as well as identifiers of the destination 1184, 1186. In reference to FIG. 7, it was discussed that compliance with shipping restrictions could be verified prior to shipping in accordance with the present invention. Section 1192 provides criteria for confirming compliance of each animal with established shipping requirements, including a checklist section 1195 to assure checking compliance with intended shipping criteria, for example, compliance with any established regulated programs, as depicted here, an “all natural” program 1193, as well as a maximum age 1189. Once all pertinent data is identified, the shipping protocol may be saved (such as through control button 1194), and then made available for access and implementation at the shipping facility, as discussed in reference to FIG. 6.

Processing System Configuration Options

Reference was made earlier herein to the “processing system” forming the various embodiments of livestock processing system as referenced herein. FIG. 12 provides a block diagram depicting one example of the various configurations of a processing system as may be used in accordance with the invention. Such a processing system 1200 may include a processor 1202 (e.g., a central processing unit (CPU) a graphics processing unit (GPU) or both), a main memory 1204 and a static memory 1206, which communicate with each other via a bus 1208. The processing system 1200 may further include a video display unit 1210 (e.g., a liquid crystal display (LCD) or a cathode ray tube (CRT)). The processing system 1200 also includes an alphanumeric input device 1212 (e.g., a keyboard), a cursor control device 1214 (e.g., a mouse), a disk drive unit 1216, a signal generation device 1218 (e.g., a speaker) and a network interface device 1220. As noted previously, at least a terminal and data input mechanism operatively associated with livestock processing system will be provided at each location where data regarding each animal is likely to be generated and/or determined. For example, terminals and data input devices would be found at both the receiving facility of FIG. 2, and the shipping facility of FIG. 6, as well as at any other locations where it would be advantageous to be able to record data regarding the animal.

The disk drive unit 1216 includes a machine-readable medium 1222 on which is stored one or more sets of instructions (e.g., software) 1224 embodying any one or more of the methodologies or functions described herein. The software 1224 may also reside, completely or at least partially, within the main memory 1204, within static memory 1206 and/or within the processor 1202 during execution thereof by the processing system 1200, the main memory 1204, the static memory and the processor 1202 also constituting machine-readable media.

The software 1224 may further be transmitted or received over a network 1226 via the network interface device 1220.

The program components described in reference to the various examples herein may be provided as a computing machine program product, or software, that may include a machine-readable medium having stored thereon instructions, which may be used to program a processing system (or other electronic device) to perform a process according to embodiments of the invention, whether presently described or not, since every conceivable variation is not enumerated herein. A machine readable medium includes any mechanism for storing or transmitting information in a form (e.g., software, processing application) readable by a machine (e.g., a computer, a personal data assistant, a cellular phone, a media center, game console, etc.). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

While the invention(s) is (are) described with reference to various implementations and exploitations, it will be understood that these embodiments are illustrative and that the scope of the invention(s) is not limited to them. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the invention(s).

What is claimed is:

1. A method of operating a livestock processing operation, comprising the acts of:
identifying a plurality of parameters regarding an animal that could occur to the animal during the time such animal is at the feedlot;
as to at least a plurality of animals at the feedlot, identifying when at least some of said identified parameters occur to each animal; and
as to each animal of said plurality, creating two electronic records with the occurring parameters, a first of said electronic records physically attached to said animal.

2. The method of claim 1, wherein the parameters are selected from a set consisting essentially of indications of weight, indications of vaccinations, animal identifiers, and a livestock category.

3. A method of operating a livestock processing operation, comprising the acts of:
electronically monitoring the time periods that a plurality of animals spend in an established zone within a first time interval;
comparing the monitored time within said zone for said plurality of animals: and
identifying those animals whose time within the zone differs from that of the majority of the other animals of said plurality.

4. The method of claim 3, wherein the established zone comprises a feed bunk.

5. The method of claim 3, wherein the electronic monitoring comprises the act of reading a RFID tag associated with each animal.
